(19) United States
(12) Patent Application Publication
(10) Pub. No.: US 2025/0008212 A1
(43) Pub. Date: Jan. 2, 2025

(54) TEACHING DEVICE

(71) Applicant: FANUC CORPORATION, Yamanashi (JP)

(72) Inventors: Misaki ITO, Yamanashi (JP); Yuta NAMIKI, Yamanashi (JP)

(21) Appl. No.: 18/711,108

(22) PCT Filed: Dec. 17, 2021
(86) PCT No.: PCT/JP2021/046870

§ 371 Date: May 17, 2024

(51) Int. Cl. H04N 23/60; B25J 15/00; B25J 19/02; G06V 10/10; G06V 10/98; H04N 23/61; H04N 23/695

(52) U.S. Cl. CPC H04N 23/64; B25J 19/023; G06V 10/10; G06V 10/993; H04N 23/61; H04N 23/695; B25J 15/00; G06V 2201/06; G06V 2201/07

(57) ABSTRACT

A teaching device comprises: an object detection unit that detects an object from a captured image obtained by imaging the object with a visual sensor; an imaging condition setting unit that sets a plurality of imaging conditions relating to the imaging of the object, and causes the object detection unit to image and detect the object with each of the plurality of imaging conditions; and a detection result determination unit that determines the detection results to formally use, on the basis of an indicator representing statistical properties of a plurality of detection results obtained by imaging and detection under the plurality of imaging conditions.

### FIELD

The present invention relates to a teaching device.

### BACKGROUND

A visual detection function of detecting a specific target object from an image in a visual field of an image capture device by using an image processing device and acquiring the position of the detected target object is known. By using the position of the target object detected by the visual detection function, a robot can handle the target object not being positioned (for example, see PTL 1).

With regard to a suction-holding ability test program, PTL 2 describes “causing a moving device to move a nozzle holder more vigorously than usual, causing an image capture device to capture images of an electronic circuit component held by a suction nozzle before and after the movement, processing data of the images acquired as a result of image capture before and after the movement, and when there is no change in the position of the electronic circuit component relative to the suction nozzle between before and after the movement, determining that an electronic circuit component holding ability of the suction nozzle is sufficient” (Abstract).

### CITATION LIST

### Patent Literature

[PTL 1] Japanese Unexamined Patent Publication (Kokai) No. 2019-113895 A

[PTL 2] Japanese Unexamined Patent Publication (Kokai) No. 2003-304095 A

### SUMMARY

### Technical Problem

Non-detection or erroneous detection may occur due to an effect by, for example, a change in an image capture position or an environment at the time of detection of a workpiece being a target object in a conventional robot system using a visual sensor as described in PTL 1. Since non-detection and erroneous detection cause a system to stop and affect a cycle time, it is preferable that occurrence of non-detection and erroneous detection be prevented.

### Solution to Problem

An embodiment of the present disclosure is a teaching device including: a target object detection unit configured to execute detection of a target object from a captured image acquired by capturing an image of the target object by a visual sensor; an image capture condition setting unit configured to set a plurality of image capture conditions related to image capture of the target object and cause the target object detection unit to execute image-capture-and-detection of the target object under each of the plurality of image capture conditions; and a detection result determination unit configured to determine a formally employed detection result, based on an index indicating a statistical property of a plurality of detection results acquired by executing the image-capture-and-detection under the plurality of image capture conditions.

### Advantageous Effects of Invention

The aforementioned configuration enables acquisition of a more precise detection result and advance prevention of occurrence of non-detection and erroneous detection.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating an entire configuration of a robot system including a teach pendant according to an embodiment.

FIG. 2 is a diagram illustrating a hardware configuration example of a robot controller and the teach pendant.

FIG. 3 is a functional block diagram of the teach pendant, the robot controller, and a visual sensor controller.

FIG. 4 is a diagram illustrating an example of providing a checkbox for automatically setting a plurality of image capture conditions on a parameter setting screen for an execution command of a visual detection function, or a detection program.

FIG. 5 is a diagram illustrating an example of a technique for automatically generating a plurality of image capture positions around an image capture position taught or specified by a user.

FIG. 6 is a flowchart illustrating image-capture-and-detection processing including processing of determining a detection result from images captured at a plurality of image capture positions.

FIG. 7 is a diagram illustrating examples of a detection result when a workpiece is detected at six image capture positions including image capture positions automatically generated by an image capture condition setting unit.

FIG. 8 is a flowchart illustrating processing of determining a formal detection result by a detection result determination unit, based on the detection results illustrated in FIG. 7.

FIG. 9 is a diagram illustrating examples of a detection result when a workpiece is detected at three image capture positions including image capture positions automatically generated by the image capture condition setting unit.

### DESCRIPTION OF EMBODIMENTS

Next, an embodiment of the present disclosure will be described with reference to drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

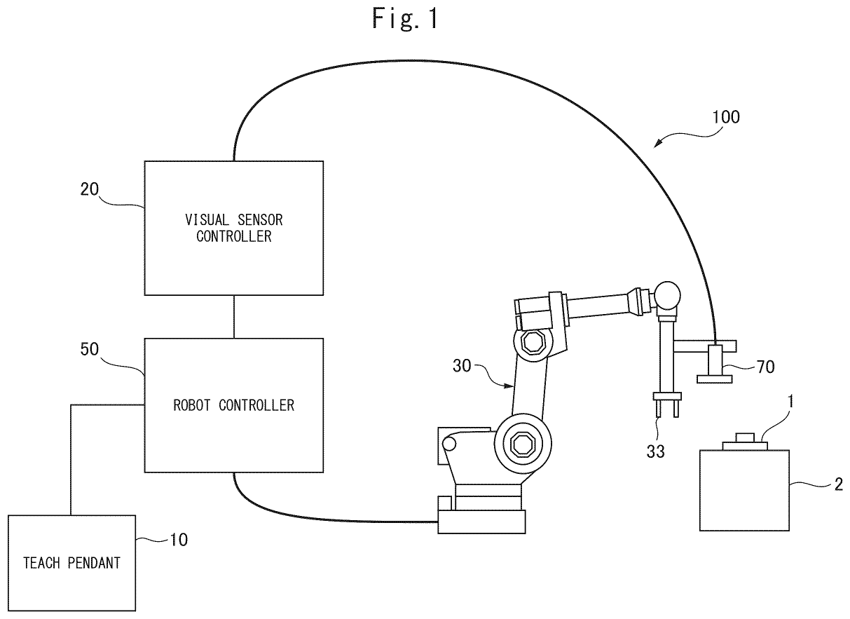

FIG. 1 is a diagram illustrating an entire configuration of a robot system 100 including a teach pendant 10 according to an embodiment. The robot system 100 includes a robot 30 including an arm tip provided with a hand (gripping device) 33, a robot controller 50 controlling the robot 30, the teach pendant 10 as a teaching device, a visual sensor 70 mounted at the arm tip of the robot 30, and a visual sensor controller 20 controlling the visual sensor 70. The visual sensor controller 20 is connected to the robot controller 50, and the teach pendant 10 is connected to the robot controller 50. The robot system 100 can detect a target object (hereinafter described as a workpiece) 1 on a workbench 2 by the visual sensor 70 and perform handling of the workpiece 1 with the hand 33 mounted on the robot 30.

While it is assumed that the robot 30 as an industrial machine is a vertical articulated robot, another type of robot may be used. The robot controller 50 controls the operation of the robot 30 in accordance with an operation program loaded in the robot controller 50 or a command input from the teach pendant 10.

The visual sensor controller 20 has a function of controlling the visual sensor 70 and a function of performing image processing on an image captured by the visual sensor 70. The visual sensor controller 20 detects the position of the workpiece 1 from an image captured by the visual sensor 70 and provides the detection result to the robot controller 50. Consequently, the robot controller 50 can perform handling of the workpiece 1 not being positioned. The detection result may include the detection position of the workpiece 1 and an evaluation value related to the detection (such as a detection score and the contrast of the image).

The visual sensor 70 may be a camera capturing a gray-scale image and/or a color image, or a stereo camera or a three-dimensional sensor that can acquire a range image and/or a three-dimensional point group. The visual sensor controller 20 holds a model pattern of a workpiece and can execute image processing of detecting a workpiece by pattern matching between an image of the workpiece in a captured image and a model pattern. It is assumed in the present embodiment that the visual sensor 70 is calibrated and that the visual sensor controller 20 holds calibration data defining a relative positional relation between the visual sensor 70 and the robot 30. Consequently, a position in an image captured by the visual sensor 70 can be transformed into a position in a coordinate system fixed to a workspace (such as a robot coordinate system).

While the visual sensor controller 20 is configured to be a device separate from the robot controller 50 in FIG. 1, a function as the visual sensor controller 20 may be embedded in the robot controller 50.

As will be described below, the robot system 100 is configured to be able to improve detection precision and prevent occurrence of non-detection and erroneous detection by determining a formal detection result by integrated use of results of detection processing performed on captured images acquired by capturing images of a target object under a plurality of image capture conditions.

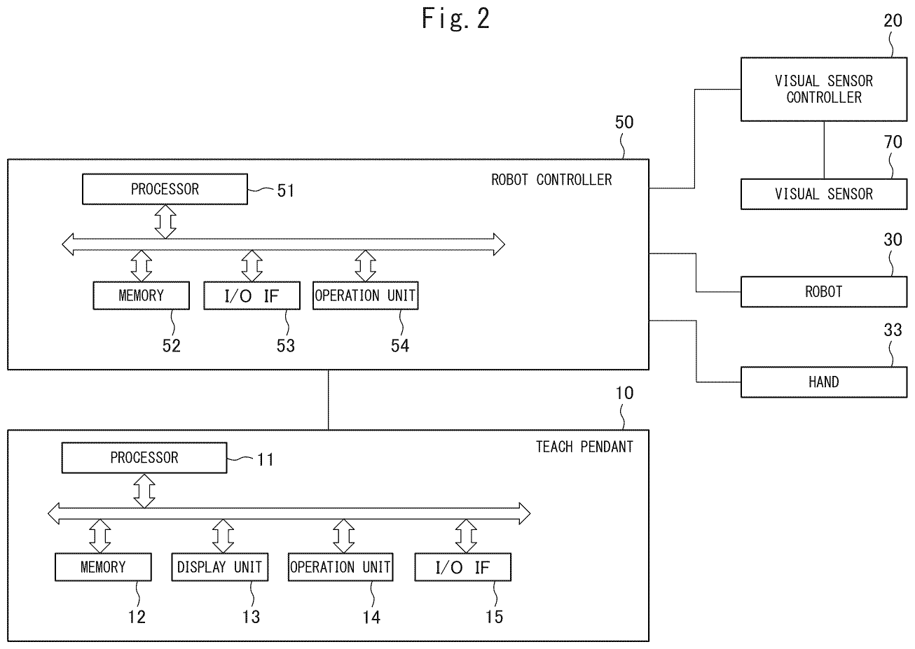

FIG. 2 is a diagram illustrating a hardware configuration example of the robot controller 50 and the teaching device 10. The robot controller 50 may have a configuration as a common computer including a memory 52 (such as a ROM, a RAM, or a nonvolatile memory), an input-output interface 53, an operation unit 54 including various operation switches, etc. that are connected to a processor 51 through a bus. The teach pendant 10 is used as a device for performing operation input and screen display for teaching operations to the robot 30 (i.e., for creating an operation program). The teach pendant 10 may have a configuration as a common computer including a memory 12 (such as a ROM, a RAM, or a nonvolatile memory), a display unit 13, an operation unit 14 configured with an input device such as a keyboard and a touch panel (software keys), an input-output interface 15, etc. that are connected to a processor 11 through a bus. Various types of information processing devices such as a tablet terminal, a smartphone, and a personal computer may be used as a teaching device in place of the teach pendant 10.

The visual sensor controller 20 may also have a configuration as a common computer including a memory (such as a ROM, a RAM, or a nonvolatile memory), an input-output interface, a display unit, an operation unit, etc. that are connected to a processor through a bus.

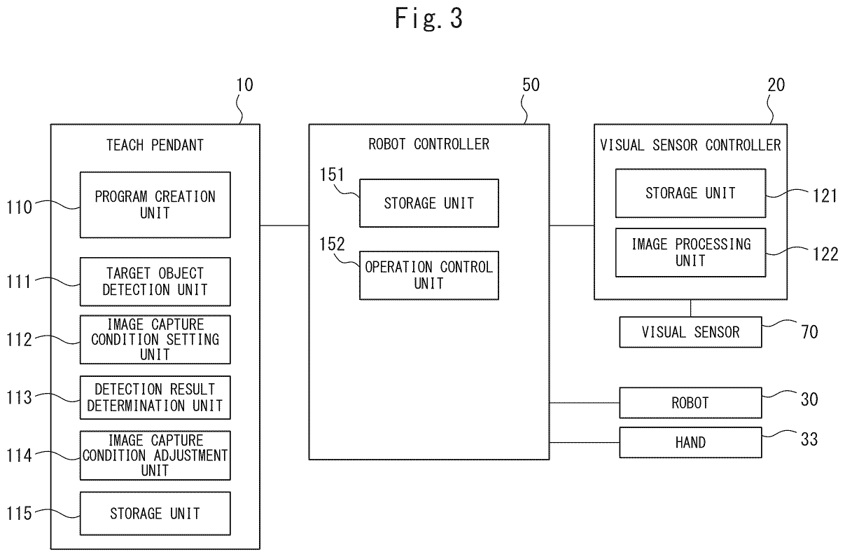

FIG. 3 is a functional block diagram of the teach pendant 10, the robot controller 50, and the visual sensor controller 20.

The visual sensor controller 20 includes a storage unit 121 and an image processing unit 122. Various types of data required in image processing (such as a model pattern), detection results, calibration data, etc. are stored in the storage unit 121. The calibration data include a relative positional relation between a coordinate system set to the robot 30 and a coordinate system set to the visual sensor 70. The calibration data may further include internal parameters related to an image capture optical system (such as a focal distance, an image size, and lens distortion). The image processing unit 122 has the function of executing pattern matching and various other types of image processing.

The robot controller 50 includes a storage unit 151 and an operation control unit 152. Various programs such as an operation program, and various other types of information used in robot control are stored in the storage unit 151. For example, the operation program is provided from the teach pendant 10. The operation control unit 152 is configured to control the operation of the robot 30 etc. in accordance with a command from the teach pendant 10 or the operation program. The control by the operation control unit 152 includes control of the hand 33 and control of the visual sensor controller 20.

As illustrated in FIG. 3, the teach pendant 10 includes a program creation unit 110, a target object detection unit 111, an image capture condition setting unit 112, a detection result determination unit 113, an image capture condition adjustment unit 114, and a storage unit 115. While the teach pendant 10 has various functions related to teaching of the robot, functional blocks focusing on functions for execution of program creation and detection using the visual sensor are illustrated in FIG. 3.

The program creation unit 110 has various functions related to program creation, such as provision of various user interface screens for program creation (teaching). A user can create various programs such as an operation program and a detection program under the support of the program creation unit 110.

The target object detection unit 111 controls the operation of capturing an image of a workpiece 1 by the visual sensor 70 and executing detection of the workpiece 1 from the captured image. More specifically, the target object detection unit 111 transmits a command for image-capture-and-detection to the robot controller 50 side and causes execution of the image-capture-and-detection operation. The target object detection unit 111 may be provided as a detection program operating under the control of the processor 11 in the teach pendant 10. For example, the target object detection unit 111 detects an image of a target object by performing matching between a feature point extracted from a captured image and a feature point of a model pattern of the target object. A feature point may be an edge point. Then, the target object detection unit 111 may determine whether the detection is successful or is a detection error by using an evaluation value (such as a detection score) indicating a degree of matching between the feature point of the target object in the captured image and the feature point of the model pattern.

The image capture condition setting unit 112 is configured to set a plurality of image capture conditions related to image capture of the workpiece 1 and causes the target object detection unit 111 to execute image-capture-and-detection processing on the workpiece 1 under each of the plurality of image capture conditions.

As an example, the image capture conditions may include at least one item out of an image capture position (or an image capture area) of a camera, an exposure time of the camera, an amount of light from a light source (such as an LED), gain, binning, a detection range, and a position and a posture of a robot. The various conditions may affect a detection result. Binning refers to a capturing technique collectively handling a plurality of pixels on an image pickup device as one pixel, and a detection range refers to a range that may be used in detection in a captured image. A position and a posture of a robot as an image capture condition are significant as information for determining the position and the posture of a camera.

The detection result determination unit 113 is configured to operate in such a way as to improve precision of a detection result by determining a formal detection result by integrated use of detection results acquired under a plurality of image capture conditions set by the image capture condition setting unit 112. The detection result determination unit 113 according to the present embodiment determines a formally employed detection result, based on an index indicating a statistical property of a plurality of detection results acquired by executing image-capture-and-detection under a plurality of image capture conditions. Indices indicating a statistical property may include a mode value, a mean value, a median value, a standard deviation, and various other statistics.

The image capture condition adjustment unit 114 is configured to adjust an image capture condition previously taught to the target object detection unit 111, based on a plurality of detection results acquired by detection under a plurality of image capture conditions set by the image capture condition setting unit 112. An image capture condition previously taught to the target object detection unit 111 refers to an image capture condition taught by a user through a parameter setting screen or taught by a user in a manner wherein an image capture condition is described in a detection program.

The storage unit 115 is used for storing various types of information including information about a teaching setting and information for programming.

Setting of a plurality of image capture conditions by the image capture condition setting unit 112 will be described. The image capture condition setting unit 112 can automatically generate a plurality of image capture conditions. The image capture condition setting unit 112 may generate a plurality of image capture conditions in accordance with specifying of parameters by a user, such as the number of image capture conditions. Forms in which the image capture condition setting unit 112 automatically generates image capture conditions in accordance with specifying of the number of image capture conditions by a user may include:
(a1) a technique of including a check item for automatically generating a plurality of image capture conditions into a parameter setting screen for setting detailed parameters of a command (such as a command icon) of a visual detection function or a processing program (a detection program), and
(a2) a technique of providing a syntax of programming for automatically generating a plurality of image capture conditions and using the syntax when text-based programming is performed.

For example, the aforementioned technique (a1) can be provided by providing a checkbox such as “AUTOMATIC SETTING OF IMAGE CAPTURE CONDITION” on a parameter setting screen. When a user checks the checkbox, the image capture condition setting unit 112 automatically generates a plurality of image capture conditions.

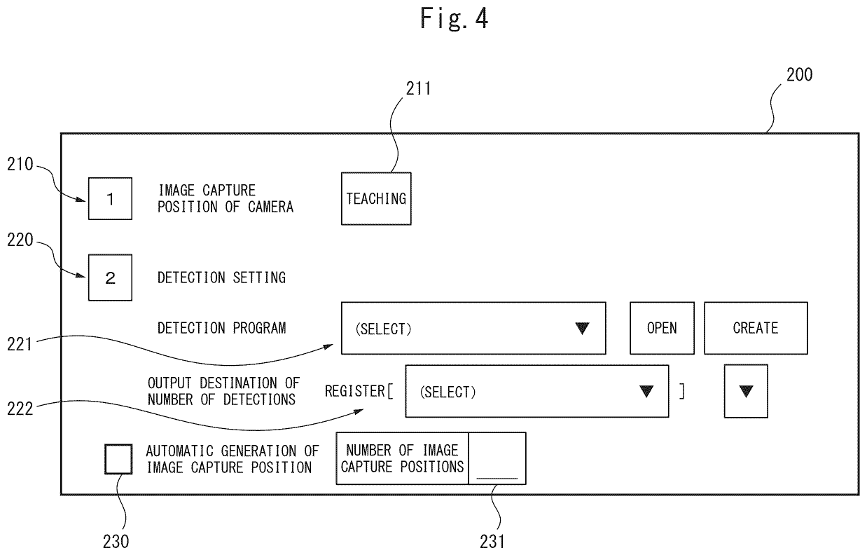

FIG. 4 illustrates an example of providing a checkbox for automatically setting a plurality of image capture conditions on a parameter setting screen for an execution command of the visual detection function, or a detection program. The parameter setting screen 200 in FIG. 4 includes “IMAGE CAPTURE POSITION OF CAMERA” 210 and “DETECTION SETTING” 220 as setting items. “DETECTION SETTING” 220 includes a specification field 221 for specifying a detection program and a specification field 222 for specifying a register for storing the number of detected workpieces. By depressing a teaching button 211 in a specification field of “IMAGE CAPTURE POSITION OF CAMERA” 210, a user can move the robot 30 by operating a jog operation button on the teach pendant 10 and perform teaching of an image capture position.

The parameter setting screen 200 further includes a checkbox 230 for automatically generating a plurality of image capture positions as image capture conditions and a specification field 231 for specifying the number of image capture positions in this case. When the checkbox 230 is checked, the image capture condition setting unit 112 automatically generates image capture positions the number of which is equal to the number specified in the specification field for the number of detections, based on the image capture position taught by the user in the specification field of “IMAGE CAPTURE POSITION OF CAMERA” 210.

For example, a specific example of the aforementioned technique (a2) may be provided by providing a command syntax as follows.
automatic image capture position generation (“number of image capture positions,” “detection program name”)

The aforementioned command provides a function of generating image capture positions the number of which is equal to the number specified by the argument “number of image capture positions” for a detection program specified by the argument “detection program name.” For example, when the aforementioned syntax is described in the operation program, the image capture condition setting unit 112 generates image capture positions the number of which is equal to the number specified by the number of image capture positions around a user-specified (taught) image capture position in the detection program.

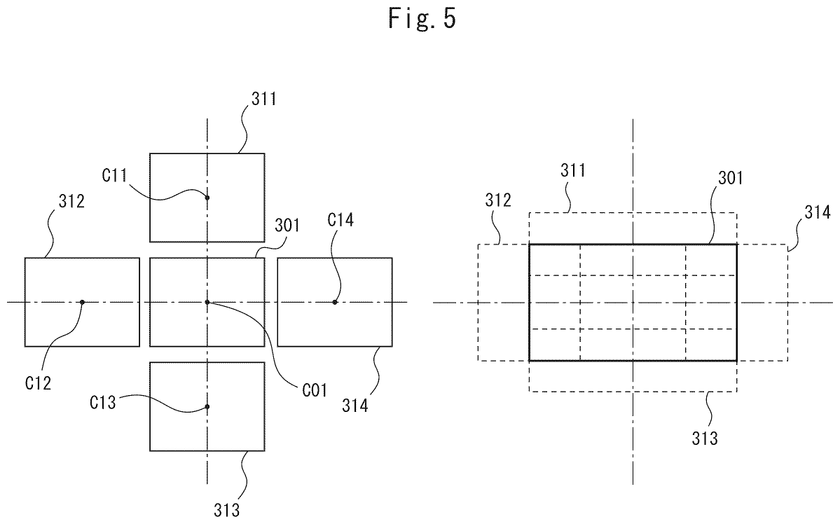

An example of a technique for automatically generating one or more image capture positions around an image capture position taught by a user will be described with reference to FIG. 5. An image capture position in this case may also include a posture. It is assumed that an image capture area 301 in the central part illustrated in FIG. 5 is an image capture area on an image capture target surface corresponding to the image capture position previously taught by the user in the “IMAGE CAPTURE POSITION OF CAMERA” 210 field on the parameter setting screen 200. For example, an image capture target surface is the placement surface of the workpiece 1 (the top surface of the workbench 2). It is further assumed that the specified number of automatically generated image capture positions is four.

As an example, the image capture condition setting unit 112 places four image capture areas 311 to 314 at equiangular intervals (at 90-degree intervals in this example) in a circumferential direction of a circle around the center C01 of the image capture area 301, as illustrated in the left part in FIG. 5. The distance from the center C01 of the image capture area 301 to each of the centers C11, C12, C13, and C14 of the respective image capture areas 311, 312, 313, and 314 may be identical. In this case, the distance from the center C01 of the image capture area 301 to each of the centers C11, C12, C13, and C14 of the respective image capture areas 311, 312, 313, and 314 may be automatically set by the image capture condition setting unit 112 according to a degree to which each of the image capture areas 311 to 314 is to overlap the image capture area 301 or may be set by a user. The five image capture areas 301 and 311 to 314 are illustrated in such a way as not to overlap each other in the left part in FIG. 5 for convenience of description; however, in practice, the image capture areas 311 to 314 may be placed to partially overlap the image capture area 301 in such a way that a target object is included in each image capture area, as illustrated on the right side of the diagram. The image capture condition setting unit 112 can determine an image capture position of the visual sensor 70 corresponding to each of the image capture areas 311 to 314, based on various conditions such as thus set positions of the image capture areas, information about an image capture optical system of the visual sensor 70 (such as the focal distance and the angle of view of a taking lens), and a relative positional relation between the visual sensor 70 and the image capture target surface. The image capture condition setting unit 112 can acquire information required for generation of an image capture condition from the robot controller 50 side. The target object detection unit 111 moves the robot 30 (the hand 33) in such a way that images of the workpiece 1 are captured at the plurality of image capture positions set by the image capture condition setting unit 112 as described above.

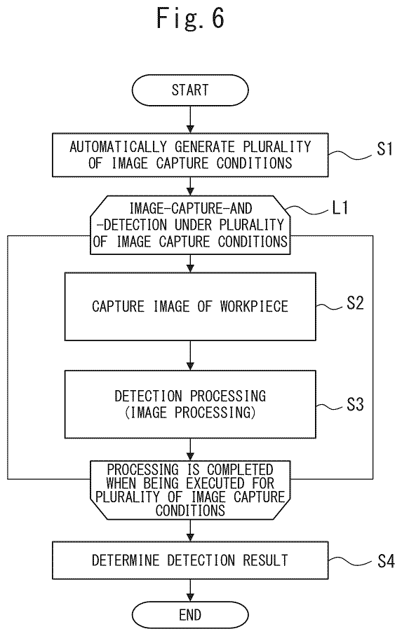

FIG. 6 is a flowchart illustrating “image-capture-and-detection processing” acquired by adding processing of determining a detection result from images captured under a plurality of image capture conditions by the aforementioned functions of the image capture condition setting unit 112 and the detection result determination unit 113 to a basic detection processing function of the target object detection unit 111 being capturing an image of a target object under a previously taught image capture condition and performing detection. The processing is provided by cooperation among the teach pendant 10, the robot controller 50, and the visual sensor controller 20 under the control of the processor 11 in the teach pendant 10.

Details of the processing in FIG. 6 will be described. When automatic setting of image capture conditions through the parameter setting screen 200 as described above is specified or automatic generation of image capture conditions by a command syntax is specified, the image capture condition setting unit 112 generates a user-specified number of image capture conditions (step S1). Then, the image capture condition setting unit 112 causes the target object detection unit 111 to repeatedly execute normal detection processing including processing of capturing an image of a workpiece (step S2) and detection processing (image processing) using the captured image (step 3) under the plurality of image capture conditions (loop processing L1). The plurality of image capture conditions undergoing the loop processing include an image capture condition previously taught by a user and an image capture condition automatically generated by the image capture condition setting unit 112.

When the image-capture-and-detection processing under the plurality of image capture conditions is completed and the processing exits from the loop, a final detection result is determined by integrated use of a plurality of detection results based on image capture under the plurality of image capture conditions (step S4).

The determination processing of a detection result in step S4 in FIG. 6 is provided by the function of the detection result determination unit 113. Various determination examples based on an index indicating a statistical property of the plurality of detection results may exist for the determination of a detection result by the detection result determination unit 113. As examples, there are determination examples (b1) to (b4) as described below.
(b1) determining a detection result to be formally employed by a majority vote method, based on the number of detection results matching each other selected from a plurality of detection results related to detection of a target object under a plurality of image capture conditions.
(b2) determining a formal detection result by averaging a plurality of detection results related to detection of a target object under a plurality of image capture conditions.
(b3) determining a formal detection result by evaluating detection results, based on a value acquired by totaling scores as a plurality of detection results under a plurality of image capture conditions. In the method, for example, the total value of scores is used as an index value in the evaluation for a group of detection results producing matching detection results. For example, when the total value of scores exceeds a threshold value, the group may be employed as a formal detection result. Alternatively, when a plurality of groups including matching detection results exists, a group to be employed as a formal detection result may be determined by comparing the total score values of the groups.
(b4) performing averaging after eliminating outliers from a plurality of detection results.

Next, an operation example (a first example) based on the aforementioned technique (b1) and an operation example (a second example) based on the aforementioned technique (b2) will be described as specific operation examples based on the image-capture-and-detection processing on a target object under a plurality of image capture conditions illustrated in FIG. 6.

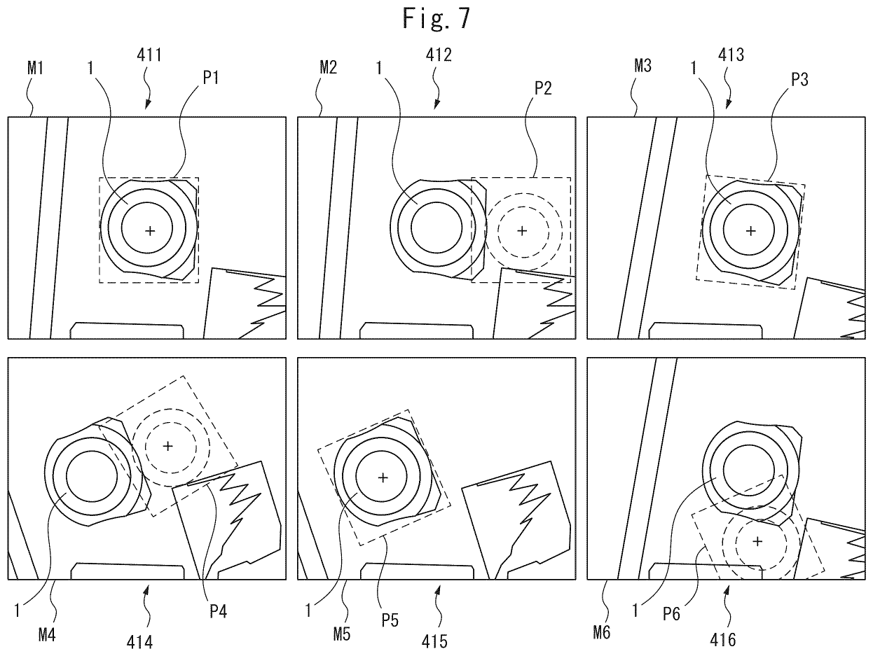

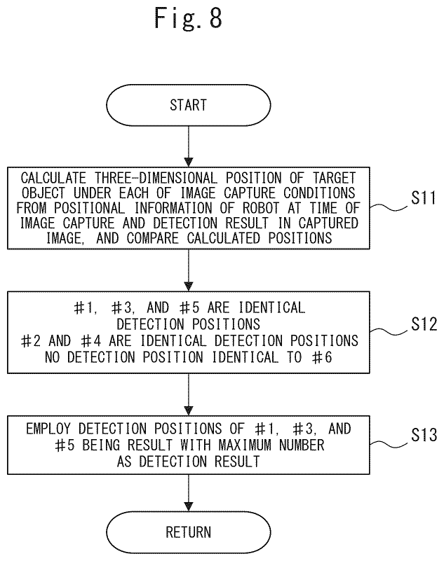

The operation example of the image-capture-and-detection processing on a target object under a plurality of image capture conditions, the example being based on the aforementioned technique (b1) (the first example), will be described with reference to FIG. 7 and FIG. 8. FIG. 7 illustrates detection results 411 to 416 when detection of a workpiece 1 is performed at six image capture positions including image capture positions automatically generated by the image capture condition setting unit 112. Each of the detection results 411 to 416 includes a captured image and a detection position. Specifically, the detection result 411 includes a captured image M1 and a detection position P1, the detection result 412 includes a captured image M2 and a detection position P2, the detection result 413 includes a captured image M3 and a detection position P3, the detection result 414 includes a captured image M4 and a detection position P4, the detection result 415 includes a captured image M5 and a detection position P5, and the detection result 416 includes a captured image M6 and a detection position P6. A detection position is a three-dimensional position of the workpiece 1 detected from a captured image being a two-dimensional image. As described above, the visual sensor controller 20 holds calibration data. The calibration data include an external parameter determining a relative positional relation between a robot coordinate system and a coordinate system set to the visual sensor 70 (a camera coordinate system) and an internal parameter related to an image capture optical system. A three-dimensional position in the robot coordinate system may be mapped onto a two-dimensional image by a transformation matrix set based on the calibration data. In other words, a three-dimensional position in the robot coordinate system is transformed into a position in the camera coordinate system by the external parameter, and the position in the camera coordinate system is mapped onto a position on an image plane by the internal parameter. Based on such mapping, a three-dimensional position in a coordinate system fixed to a workspace (the robot coordinate system) can be calculated from a position in an image captured by the visual sensor 70.

The detection results 411 to 416 in FIG. 7 are acquired by capturing images of the workpiece 1 from different image capture positions, respectively. The detection position P1 in the detection result 411, the detection position P3 in the detection result 413, and the detection position P5 in the detection result 415 match in this case. Further, the detection position P2 in the detection result 412 and the detection position P4 in the detection result 414 match, and there is no detection position identical to the detection position P6. When detection positions (detection results) are herein described to match or agree, it is assumed that a case in which, even when the detection positions (detection results) do not strictly match, the difference between the detection positions is within a predetermined allowable range (for example, a degree of the difference not causing an issue in handling of the workpiece 1 by the robot 30) is included. In the example in FIG. 7, the detection positions P1, P3, and P5 are correct detection positions, and the detection position P2, the detection position P4, and the detection position P6 are erroneous detections.

FIG. 8 illustrates, as a flowchart, processing performed by the detection result determination unit 113 when the detection result determination unit 113 determines a formal detection result (step S4 in FIG. 6) in accordance with the aforementioned determination technique (b1), based on the detection results 411 to 416 illustrated in FIG. 7. First, the detection result determination unit 113 compares the six detection positions P1 to P6 in the detection results 411 to 416 (step S11). A detection position (a three-dimensional position) can be found from positional information of the robot 30 at the time of image capture and a detection result in a captured image. In this case, the detection result determination unit 113 recognizes that the detection positions P1, P3, and P5 are identical detection positions, the detection positions P2 and P4 are identical detection positions, and there is no detection position identical to the detection result P6 (step S12).

Next, the detection result determination unit 113 employs detection positions maximizing the number of captured images, detection positions of which are identical (the detection positions P1, P3, and P5 in the detection results 411, 413, and 415 in this case), as formal detection positions (step S13).

Thus, a configuration employing detection results with a maximum number of matching detection results (i.e., the mode value) as formal detection results enables improved reliability of the detection results and advance prevention of occurrence of non-detection and erroneous detection.

Next, adjustment of an image capture condition previously taught to the target object detection unit 111, the adjustment being performed by the image capture condition adjustment unit 114, will be described. As understood from the aforementioned description, an image capture condition producing detection results with a smaller number of matching detection results (the detection positions P2 and P4 or the detection position P6) can be positioned as “an image capture condition with a lower probability of successful detection” than an image capture condition producing detection results with a maximum number of matching detection results (the detection positions P1, P3, and P5). On the other hand, an image capture condition producing detection results with a maximum number of matching detection results (the detection positions P1, P3, and P5) can be positioned as “an image capture condition with a higher probability of successful detection” than an image capture condition producing detection results with a smaller number of matching detection results (the detection positions P2 and P4 or the detection result P6). With regard to an evaluation value (such as a detection score) included in a detection result, an image capture condition with a lower evaluation value can be assumed to be an image capture condition with a lower probability of successful detection. Further, an image capture condition with a higher evaluation value can be assumed to be an image capture condition with a higher probability of successful detection.

Therefore, the image capture condition adjustment unit 114 can extract “an image capture condition positioned as being unsuitable for use in image-capture-and-detection” and/or “an image capture condition positioned as being suitable for use in image-capture-and-detection” from a plurality of image capture conditions set by the image capture condition setting unit 112 by using at least either one of decision criteria being:
(c1) an image capture condition producing a greater number of detection results matching each other is an image capture condition with a higher probability of successful detection; and
(c2) an image capture condition producing a result with a higher predetermined evaluation value related to a detection result is an image capture condition with a higher probability of successful detection.

Then, the image capture condition adjustment unit 114 can adjust an image capture condition previously taught to the target object detection unit 111 from the extracted “image capture condition positioned as being unsuitable for use in image-capture-and-detection” and/or the extracted “image capture condition positioned as being suitable for use in image-capture-and-detection.” It should be noted that “(c1) an image capture condition producing a greater number of detection results matching each other is an image capture condition with a higher probability of successful detection” is equivalent to “an image capture condition producing a smaller number of detection results matching each other is an image capture condition with a lower probability of successful detection.” Further, “(c2) an image capture condition producing a result with a higher predetermined evaluation value related to a detection result is an image capture condition with a higher probability of successful detection” is equivalent to “an image capture condition with a lower predetermined evaluation value related to a detection result is an image capture condition with a lower probability of successful detection.”

The image capture condition adjustment unit 114 may extract an image capture condition producing the detection results P1, P3, and P5 as “an image capture condition positioned as being suitable for use in image-capture-and-detection” in accordance with the aforementioned decision criterion (c1). Further, the image capture condition adjustment unit 114 may extract an image capture condition producing the detection positions P2 and P4 or the detection result P6 as “an image capture condition positioned as being unsuitable for use in image-capture-and-detection” in accordance with the aforementioned decision criterion (c1).

The detection positions P1, P3, and P5 are correct detection positions, and the detection positions P2 and P4 and the detection position P6 are erroneous detections. In this case, detection scores of the detection positions P1, P3, and P5 are higher than detection scores of the detection results P2 and P4 or the detection result P6. Accordingly, the image capture condition adjustment unit 114 may extract an image capture condition producing the detection results P1, P3, and P5 as “an image capture condition positioned as being suitable for use in image-capture-and-detection” in accordance with the aforementioned decision criterion (c2). Further, the image capture condition adjustment unit 114 may extract an image capture condition producing the detection positions P2 and P4 or the detection result P6 as “an image capture condition positioned as being unsuitable for use in image-capture-and-detection” in accordance with the aforementioned decision criterion (c2).

When the decision criterion (c2) is used with the decision criterion (c1), for example, an operation such as:
(d1) an image capture condition producing detection results with a detection score less than a predetermined value is not used as “an image capture condition positioned as being suitable for use in image-capture-and-detection” even when the image capture condition is extracted as “an image capture condition positioned as being suitable for use in image-capture-and-detection” in accordance with the determination criterion (c1); and/or
(d2) when there are two groups with an equal number of detection results matching each other, an image capture condition producing detection results in a group with a higher detection score value (such as a mean value or a total value) is determined to be “an image capture condition positioned as being suitable for use in image-capture-and-detection” may be performed.

The image capture condition adjustment unit 114 stores “an image capture condition positioned as being unsuitable for use in image-capture-and-detection” and/or “an image capture condition positioned as being suitable for use in image-capture-and-detection” extracted as described above into the storage unit 115 and allows the conditions to be used for adjustment of an image capture condition. The storage unit 115 may include various storage devices that can be configured in the memory 52, such as a storage area of variables referenceable from a program and a file in a nonvolatile memory. Alternatively, the storage unit 115 may be configured outside the teach pendant 10.

As an example, when an image capture condition being taught to the detection program by a user or being previously specified corresponds to “an image capture condition positioned as being unsuitable for use in image-capture-and-detection,” the image capture condition adjustment unit 114 may output a message prompting the user to change the image capture condition or, when “an image capture condition positioned as being suitable for use in image-capture-and-detection” is saved in the storage unit 115, may operate in such a way as to update the image capture condition being taught to the detection program or being preset with “the image capture condition positioned as being suitable for use in image-capture-and-detection.” Such an operation can prevent use of “an image capture condition positioned as being unsuitable for use in image-capture-and-detection” as an image capture condition by the target object detection unit 111.

When detection errors frequently occur in actual operation of executing a detection program by using a previously taught image capture condition, the configuration as described above enables acquisition of “an image capture condition positioned as being suitable for use in image-capture-and-detection” or “an image capture condition positioned as being unsuitable for use in image-capture-and-detection” by executing the processing illustrated in FIG. 6 once and enables suitable adjustment of the image capture condition.

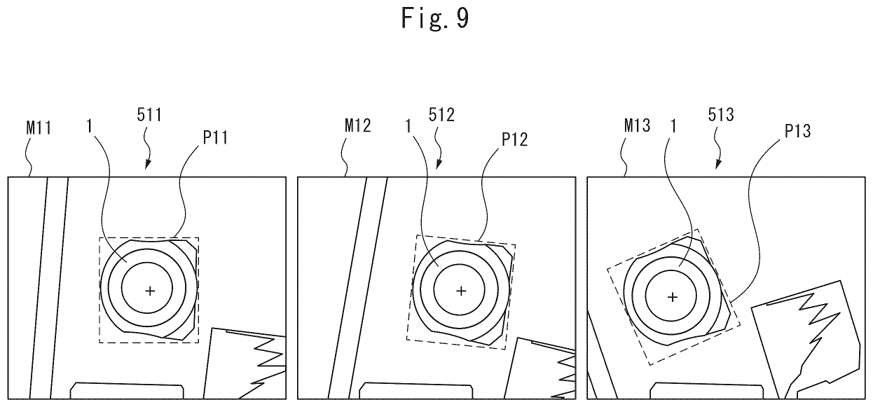

Next, an operation example (the second example) of the image-capture-and-detection processing on a target object under a plurality of image capture conditions, the example being based on the aforementioned technique (b2), i.e., “the method of determining a formal detection result by averaging a plurality of detection results related to detection of a target object under a plurality of image capture conditions” will be described with reference to FIG. 9. Detection results when a workpiece 1 is detected at three image capture positions including image capture positions automatically generated by the image capture condition setting unit 112 are denoted by detection results 511 to 513 as illustrated in FIG. 9. The detection result 511 includes a captured image M11 and a detection position P11, the detection result 512 includes a captured image M12 and a detection position P12, and the detection result 513 includes a captured image M13 and a detection position P13. Each of the detection positions P11, P12, and P13 in the example in FIG. 9 is a correct detection position (a detection result not being an erroneous detection).

As a formal detection position, the detection result determination unit 113 employs the mean value of the detection positions P11 to P13 being three detection results. In general, there are variations in three-dimensional positions of the workpiece 1 as detection results, and therefore detection precision can be improved by averaging the detection positions (for example, the mean value of the detection positions P11 to P13 is determined to be a formal detection position). When an erroneous detection (a detection result with an evaluation value less than a predetermined value) is included in the detection positions P11, P12, and P13, a detection position causing the erroneous detection may be removed from averaging. While an example of determining a mean value as a formal detection result has been described in this example, an example of determining a median value as a formal detection result may also be viable.

When the detection result determination unit 113 performs the operation as described above based on the aforementioned technique (b2), the image capture condition adjustment unit 114 can also extract “an image capture condition positioned as being unsuitable for use in image-capture-and-detection” and/or “an image capture condition positioned as being suitable for use in image-capture-and-detection” under a plurality of image capture conditions set by the image capture condition setting unit 112, by using the aforementioned decision criterion (c2), i.e., “an image capture condition producing a result with a higher predetermined evaluation value related to a detection result is an image capture condition with a higher probability of successful detection.” Then, the image capture condition adjustment unit 114 can perform adjustment of an image capture condition as described above, i.e., adjustment preventing use of “an image capture condition positioned as being unsuitable for use in image-capture-and-detection” as an image capture condition by the target object detection unit 111 or update of an image capture condition previously taught to the target object detection unit 111 with “an image capture condition positioned as being suitable for use in image-capture-and-detection.”

Since the detection positions P1, P3, and P5 in the first example illustrated in FIG. 7 may also include variations, the detection result determination unit 113 may perform averaging on the detection positions P1, P3, and P5 employed in the first example and determine the result to be a formal detection position in the first example.

As described above, the present embodiment enables acquisition of a more precise detection result and advance prevention of occurrence of non-detection and erroneous detection.

While the present invention has been described above by using the typical embodiments, it may be understood by a person skilled in the art that changes, and various other changes, omissions, and additions can be made to the aforementioned embodiments without departing from the scope of the present invention.

While the robot system described in the aforementioned embodiment is configured to be provided with a visual sensor on the robot and capture an image of a workpiece placed on a workbench, various functions described in the aforementioned embodiment may be applied to a system in which a visual sensor is fixed to a workspace in which a robot is installed, and a workpiece is presented to the visual sensor by moving the robot gripping the workpiece. A plurality of image capture positions being set by the image capture condition setting unit 112 and being described with reference to FIG. 5 are relative image capture positions of the visual sensor 70 with respect to a workpiece. Accordingly, in such a system configuration, the target object detection unit 111 may perform control (i.e., issue a command to the robot controller) of moving a workpiece gripped by the robot in such a way that images of the workpiece are captured by the visual sensor 70 at a plurality of image capture positions set by the image capture condition setting unit 112. An image capture target surface in this case may be defined to be a surface including the surface of the workpiece.

While an operation of automatically generating a plurality of image capture conditions by the image capture condition setting unit 112 has been described in the aforementioned embodiment, the image capture condition setting unit 112 may operate in such a way as to accept a user input specifying a plurality of image capture conditions and cause the target object detection unit 111 to use the plurality of user-input image capture conditions.

The arrangement of the functions in the functional block diagram illustrated in FIG. 3 is an example, and there may be various modified examples related to arrangement of the functions. For example, a configuration example in which the target object detection unit 111, the image capture condition setting unit 112, the detection result determination unit 113, the image capture condition adjustment unit 114 and the storage unit 115 that are placed in the teach pendant 10 are placed on the robot controller 50 side may be employed. In this case, the functions of the visual sensor controller 20 may be included in the robot controller 50. In this case, all functions provided by the teach pendant 10 and the robot controller 50 may be defined as a teaching device.

The functional blocks of the teach pendant 10, the robot controller 50, and the visual sensor controller 20 that are illustrated in FIG. 3 may be provided by executing various types of software stored in a storage device by processors of the devices or may be provided by a configuration mainly based on hardware such as an application specific integrated circuit (ASIC).

A program executing various types of processing such as the image-capture-and-detection processing according to the aforementioned embodiment may be recorded on various computer-readable recording media (such as semiconductor memories such as a ROM, an EEPROM, and a flash memory; a magnetic recording medium; and optical disks such as a CD-ROM and a DVD-ROM).

### REFERENCE SIGNS LIST

1 Workpiece
2 Workbench
10 Teach pendant
11 Processor
12 Memory
13 Display unit
14 Operation unit
15 Input-output interface
20 Visual sensor controller
30 Robot
33 Hand
50 Robot controller
51 Processor
52 Memory
53 Input-output interface
54 Operation unit
70 Visual sensor
100 Robot system
110 Program creation unit
111 Target object detection unit
112 Image capture condition setting unit
113 Detection result determination unit
114 Image capture condition adjustment unit
115 Storage unit
151 Storage unit
152 Operation control unit
121 Storage unit
122 Image processing unit
200 Parameter setting screen
411 to 416 Detection result
511 to 513 Detection result

1. A teaching device comprising:
a target object detection unit configured to execute detection of a target object from a captured image acquired by capturing an image of the target object by a visual sensor;
an image capture condition setting unit configured to set a plurality of image capture conditions related to image capture of the target object and cause the target object detection unit to execute image-capture-and-detection of the target object under each of the plurality of image capture conditions; and
a detection result determination unit configured to determine a formally employed detection result, based on an index indicating a statistical property of a plurality of detection results acquired by executing the image-capture-and-detection under the plurality of image capture conditions.

2. The teaching device according to claim 1, wherein
the detection result determination unit determines the formally employed detection result, based on a mode value as the index, the mode value being related to the plurality of detection results.

3. The teaching device according to claim 2, wherein
the detection result determination unit further averages one or more detection results determined as the formally employed detection results out of the plurality of detection results and uses an averaged result as the formally employed detection result.

4. The teaching device according to claim 2, further comprising
an image capture condition adjustment unit configured to adjust an image capture condition previously taught to the target object detection unit, based on the plurality of detection results, wherein
the image capture condition adjustment unit
extracts an image capture condition positioned as being unsuitable for use in the image-capture-and-detection or an image capture condition positioned as being suitable for use in the image-capture-and-detection from the plurality of image capture conditions by using at least one of two decision criteria being:
(1) an image capture condition producing a greater number of detection results matching each other is an image capture condition with a higher probability of successful detection; and
(2) an image capture condition producing a result with a higher predetermined evaluation value related to a detection result is an image capture condition with a higher probability of successful detection, and
adjusts an image capture condition previously taught to the target object detection unit with an extracted image capture condition positioned as being unsuitable for use in the image-capture-and-detection or an extracted image capture condition positioned as being suitable for use in the image-capture-and-detection.

5. The teaching device according to claim 4, wherein
the image capture condition adjustment unit extracts an image capture condition positioned as being unsuitable for use in the image-capture-and-detection and makes an adjustment in such a way that the image capture condition positioned as being unsuitable for use in the image-capture-and-detection is not used as an image capture condition by the target object detection unit.

6. The teaching device according to claim 4, wherein
the image capture condition adjustment unit extracts an image capture condition positioned as being suitable for use in the image-capture-and-detection and updates an image capture condition previously taught to the target object detection unit with the image capture condition positioned as being suitable for use in the image-capture-and-detection.

7. The teaching device according to claim 1, wherein
the detection result determination unit determines the formally employed detection result by using a value acquired by averaging the plurality of detection results as the index.

8. The teaching device according to claim 7, further comprising
an image capture condition adjustment unit configured to adjust an image capture condition previously taught to the target object detection unit, based on the plurality of detection results, wherein
the image capture condition adjustment unit
extracts an image capture condition positioned as being unsuitable for use in the image-capture-and-detection or an image capture condition positioned as being suitable for use in the image-capture-and-detection from the plurality of image capture conditions by using a decision criterion that an image capture condition producing a result with a higher predetermined evaluation value related to a detection result is an image capture condition with a higher probability of successful detection, and
adjusts an image capture condition previously taught to the target object detection unit with an extracted image capture condition positioned as being unsuitable for use in the image-capture-and-detection or an extracted image capture condition positioned as being suitable for use in the image-capture-and-detection.

9. The teaching device according to claim 8, wherein
the image capture condition adjustment unit extracts an image capture condition positioned as being unsuitable for use in the image-capture-and-detection and makes an adjustment in such a way that the image capture condition positioned as being unsuitable for use in the image-capture-and-detection is not used as an image capture condition by the target object detection unit.

10. The teaching device according to claim 8, wherein
the image capture condition adjustment unit extracts an image capture condition positioned as being suitable for use in the image-capture-and-detection and updates an image capture condition previously taught to the target object detection unit with the image capture condition positioned as being suitable for the use in image-capture-and-detection.

11. The teaching device according to claim 1, wherein
the image capture condition setting unit sets the plurality of image capture conditions by generating one or more image capture conditions, based on one image capture condition being a standard.

12. The teaching device according to claim 11, wherein
the one image capture condition being the standard is an image capture condition previously taught to the target object detection unit.

13. The teaching device according to claim 11, wherein
the image capture condition is an image capture position of the visual sensor, and
the image capture condition setting unit determines one or more image capture positions around one image capture position being the standard in such a way that one or more image capture areas based on the one or more image capture positions on an image capture target surface partially overlap an image capture area based on the one image capture position being the standard on the image capture target surface.

14. The teaching device according to claim 13, wherein
the visual sensor is provided on a robot, and
the target object detection unit moves the robot in such a way that image capture of the target object is performed at a plurality of image capture positions set by the image capture condition setting unit.

15. The teaching device according to claim 13, wherein
the visual sensor is fixed to a workspace in which a robot provided with a hand is installed,
the robot grips the target object with the hand, and
the target object detection unit moves the robot in such a way that image capture of the target object is performed at a plurality of image capture positions set by the image capture condition setting unit.
